(19) United States
(12) Patent Application Publication
(10) Pub. No.: US 2019/0344994 A1
(43) Pub. Date: Nov. 14, 2019

(54) NANOMATERIAL ENCASED TRANSMISSIVE WIRE

(71) Applicant: Raytheon Company, Waltham, MA (US)

(72) Inventors: Kyle L. Grosse, Dallas, TX (US); Gary A. Frazier, Garland, TX (US); Catherine Trent, Allen, TX (US); Jonathan L. Frasch, McKinney, TX (US)

(21) Appl. No.: 15/975,950

(22) Filed: May 10, 2018

(51) Int. Cl. B65H 81/06; H01B 13/00

(52) U.S. Cl. CPC B65H 81/06; H01B 7/17; H01B 13/0036

(57) ABSTRACT

Provided is a transmissive wire of a micrometer or nanometer scale diameter, and a method of forming such a transmissive wire, that can be produced and handled at macrometer scale, and which has a mechanical strength suitable for being formed and handled at a macrometer scale. A transmissive element having micrometer or nanometer scale thickness may be continuously applied, such as fixedly applied, to a nanomaterial structure, or vice versa, and the combined structure jointly wrapped about an axis of the nanomaterial structure to produce a wire. In one example, a continuously formed transmissive element may be continuously applied to a continuously formed length of a nanomaterial sheet with the combined structure being wrapped about a longitudinal axis of the nanomaterial sheet to form a transmissive wire having a micrometer or nanometer scale diameter along the longitudinal axis of the formed transmissive wire.

### FIELD OF THE INVENTION

The invention relates generally to a nanomaterial encasement of a transmissive material, and to a method of making the same. More particularly, the invention relates to a transmissive wire having a micrometer or nanometer scale diameter that can be produced and handled at a macrometer scale.

### DESCRIPTION OF THE RELATED ART

Conventional transmissive wires, such as for any one or more of electrical, thermal, or optical transmission along the wire, typically lose their mechanical integrity for ease of handling as a wire diameter of the transmissive wire decreases. Where the wire diameter decreases to a tens of micrometer to nanometer scales, handling of conventional transmissive wires is significantly frustrated by reduced tensile strength, shear strength, bending strength, and general fragility of such wires.

### SUMMARY OF THE INVENTION

The present disclosure provides a transmissive wire of a micrometer or nanometer scale diameter, and a method of forming such transmissive wire, that can be produced and handled at macrometer scale, and which has a reduced mechanical degradation of the transmissive wire as compared to such conventional transmissive wires. Generally, a core transmissive structure is protected and strengthened by a relatively stronger external structure that may or may not comprise a transmissive material. A transmissive element having micrometer or nanometer scale thickness may be continuously applied, such as fixedly applied, to a nanomaterial structure, or vice versa, and the combined structure jointly wrapped about an axis of the combined structure to produce the transmissive wire. In one example, a continuously formed transmissive element may be applied to a continuously formed length of a nanomaterial sheet with the combined structure being wrapped about a longitudinal axis of the combined structure to form a transmissive wire having a micrometer or nanometer scale diameter along the longitudinal axis of the formed transmissive wire. The method of forming the exemplary transmissive wire may provide for a generally highly conductive, mechanically robust transmissive wire, which may have additional thermal, optical, or chemical advantages, for example.

According to one aspect of the present invention, a transmissive wire includes a sheet comprising a nanomaterial, the sheet being wrapped about a longitudinal axis of the sheet, and a transmissive element enabling transmission of a signal along the transmissive wire, the transmissive element continuously extending along the transmissive wire and being wrapped within the sheet, at least a portion of the transmissive element at each distance along a longitudinal length of the transmissive wire being radially inwardly spaced from a radially outermost portion of the wrapped sheet at the same respective distance.

The transmissive wire may have an average diameter over the longitudinal length of the transmissive wire of 0.5 micrometers to 20 micrometers.

The longitudinal axis of the sheet about which the sheet is wrapped may be disposed along a laterally-extending free edge of the sheet, wherein one laterally-extending free edge of the sheet is wrapped about the opposing laterally-extending free edge of the sheet.

A full circumferential extent of the transmissive element about a longitudinal axis of the transmissive wire may be retained within the transmissive wire, spaced radially inward from a radially outermost circumferential extent of the wrapped sheet.

The transmissive element may include a layer affixed to the sheet such that the transmissive element and the at sheet are jointly wrapped about the longitudinal axis of the sheet.

The transmissive element may include a layer affixed to a longitudinally extending lateral edge portion of the sheet, and wherein an opposite lateral edge portion is free from transmissive element affixation.

The transmissive element may include a conductive metal.

The transmissive element may include a ceramic.

The sheet may include nanotubes.

According to another aspect of the present invention, a transmissive wire includes a sheet comprising a nanomaterial, the sheet being wrapped about a longitudinal axis of the sheet, and a transmissive element enabling transmission of a signal along the transmissive wire, the transmissive element continuously extending along the transmissive wire and being wrapped within the sheet, at least a portion of the transmissive element at each distance along a longitudinal length of the transmissive wire being radially inwardly spaced from a radially outermost portion of the wrapped sheet at the same respective distance. The transmissive element is formed from a material that is deposited to the sheet such that the transmissive element is affixed to the sheet allowing for the transmissive element and the sheet to be jointly wrapped about a longitudinal axis of the sheet.

According to yet another aspect of the present invention, a method of making a nanomaterial encased transmissive wire includes continuously applying a transmissive element along a continuous length of a sheet comprising a nanomaterial, the transmissive element enabling transmission of a signal along the transmissive wire, and wrapping the sheet about the transmissive element and about a longitudinal axis of the sheet to form the transmissive wire, wherein at least a portion of the transmissive element at each distance along a longitudinal length of the transmissive wire is radially inwardly spaced from a radially outermost portion of the wrapped sheet at the same respective distance.

The applying step may include forming the transmissive layer on the sheet by evaporation, sputtering, electroplating, vapor deposition, or atomic layer deposition.

The applying step may include affixing the transmissive element to the sheet such that the transmissive element and the sheet are jointly wrappable about the longitudinal axis of the sheet.

The applying step may include applying the transmissive element to a longitudinally extending lateral edge portion of the sheet, wherein an opposite lateral edge portion is free from transmissive element application.

The applying step may include applying a conductive metal to the sheet.

The applying step may include applying a ceramic to the sheet.

The wrapping step may include forming a transmissive wire having an average diameter over the longitudinal length of the transmissive wire of 0.5 micrometers to 20 micrometers.

The wrapping step may include retaining a full circumferential extent of the transmissive element spaced radially inward from a radially outermost circumferential extent of the wrapped sheet.

The wrapping step may include wrapping one laterally-extending free edge of the sheet about the opposing laterally-extending free edge of the sheet, wherein the longitudinal axis of the sheet about which the sheet is wrapped is disposed at a laterally-extending free edge of the sheet.

The sheet and the transmissive element may comprise a first sheet and a first transmissive element, and the method may further include continuously applying a second transmissive element along a continuous length of a second sheet comprising a nanomaterial, and wrapping the second sheet and the second transmissive element about the first sheet and the first transmissive element.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

The annexed drawings, which are not necessarily to scale, show various aspects of the disclosure, some of which may be shown schematically.

FIG. 1 is a schematic view of an exemplary method in accordance with the present invention for forming an exemplary transmissive wire in accordance with the present invention.

FIG. 2 is a cross-sectional view of the transmissive wire of FIG. 1, taken orthogonal a longitudinal axis of the transmissive wire.

FIG. 3 is a schematic view of another exemplary method in accordance with the present invention for forming another exemplary transmissive wire in accordance with the present invention.

FIG. 4 is a cross-sectional view of the transmissive wire of FIG. 3, taken orthogonal a longitudinal axis of the transmissive wire.

FIG. 5 is a schematic view of yet another exemplary method in accordance with the present invention for forming yet another exemplary transmissive wire in accordance with the present invention.

FIG. 6 is a cross-sectional view of the transmissive wire of FIG. 5, taken orthogonal a longitudinal axis of the transmissive wire.

FIG. 7 is a schematic view of still another exemplary method in accordance with the present invention for forming still another exemplary transmissive wire in accordance with the present invention.

FIG. 8 is a cross-sectional view of the transmissive wire of FIG. 7, taken orthogonal a longitudinal axis of the transmissive wire.

FIG. 9 is a schematic view of another exemplary method in accordance with the present invention for forming another exemplary transmissive wire in accordance with the present invention.

FIG. 10 is a cross-sectional view of the transmissive wire of FIG. 9, taken orthogonal a longitudinal axis of the transmissive wire.

FIG. 11 is a cross-sectional view of an exemplary transmissive wire formed by a combination of the methods of the aforementioned figures.

FIG. 12 is a cross-sectional view of another exemplary transmissive wire formed by a combination of the methods of the aforementioned figures.

### DETAILED DESCRIPTION

The present invention provides a transmissive wire of a micrometer or nanometer scale diameter, and a method of forming such transmissive wire, that can be produced and handled at macrometer scale, and which has a mechanical strength suitable for being formed and handled at a macrometer scale. The transmissive wire may be suitable for one or more of mechanical, thermal, or optical transmission and may have additional mechanically resistive, chemically resistive, thermally resistive, or electro-magnetically resistive properties. The transmissive wires may be beneficially used as a typical wire, in an EMI grid, or as part of an antenna, for example. Other uses may include wrapping of the wire about another structure, such as a dome or other structure protecting transmission equipment, such as a radome protecting radar equipment.

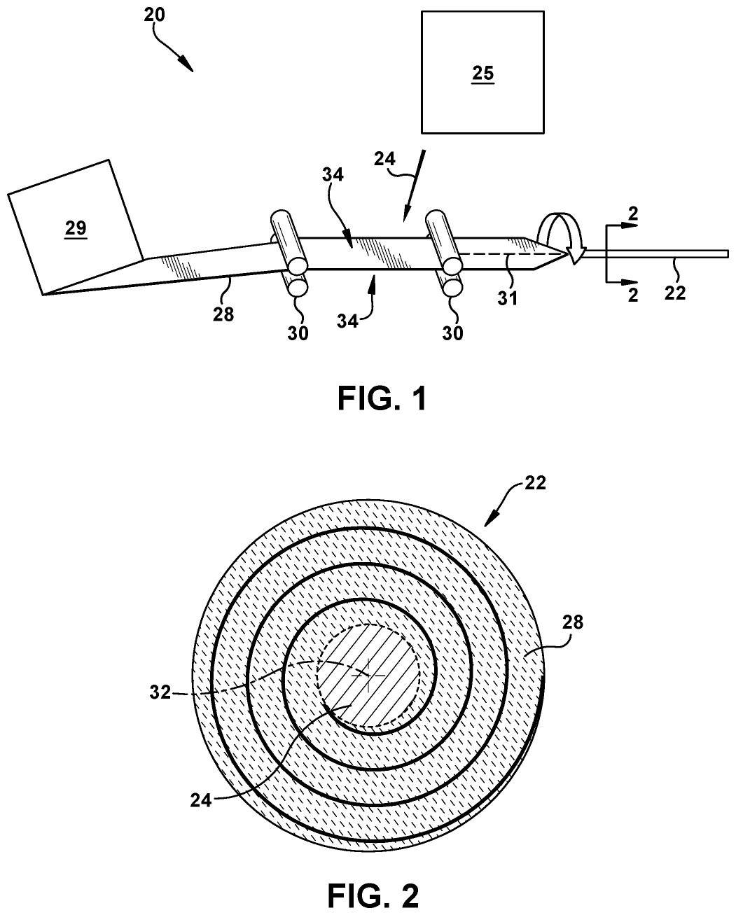

Turning first to FIGS. 1 and 2, an exemplary method of forming an exemplary transmissive wire, and the makeup of the transmissive wire are depicted. FIG. 1 schematically illustrates an exemplary process 20 of forming a continuous length of a transmissive wire 22, which wire is shown in cross-section at FIG. 2, taken along section 2-2 of FIG. 1. Generally, a continuous length of transmissive element 24 is provided from a supply 25 and then applied along a continuous length of a sheet 28 provided from a wire supply 29.

The continuous lengths of the sheet 28 and/or the transmissive element 24 may be jointly supported along their lengths (both separated and engaged lengths) by one or more sets of supports such as rollers 30. The rollers 30 may be spaced apart any suitable distance. At a second location spaced from a first location at which the sheet 28 and the transmissive element 24 are applied relative to one another, the sheet and transmissive element combination is wrapped about a longitudinal axis 31 of the sheet 28 to form the transmissive wire 22. The wrapping may include any of twisting, rolling, spinning, etc., which may be conducted about any one or more longitudinal axes of the sheet 28, such as about a central longitudinal axis of the sheet 28, in a clockwise or counterclockwise direction. Where suitable, such wrapping also may be conducted about a lateral axis of the sheet 28.

The resulting transmissive wire 22 formed from the transmissive element 24 and the nanomaterial sheet 28 generally includes (a) at least one sheet 28 comprising a nanomaterial and wrapped about a longitudinal axis of the sheet 28, and (b) the transmissive element 24, with each of the sheet 28 and the transmissive element 24 continuously extending along the transmissive wire 22. As a result of the wrapping, at least a portion of the transmissive element 24 at each distance along the longitudinal length of the transmissive wire 22 is radially inwardly spaced from a radially outermost portion of the wrapped sheet 28 at the same respective distance.

As illustrated in FIG. 2, showing a cross-section taken generally orthogonal a central longitudinal axis 32 of the transmissive wire 22, the transmissive element 24 is at least partially encased by the protective material of the sheet 28. In the particular embodiment of FIG. 2, a full circumferential extent of the transmissive element 24 is retained within the wrapped sheet 28. Thus, each section of transmissive element 24 along a length of the transmissive wire 22 is spaced radially inward from all radially outermost portions of the wrapped sheet 28 at each point/position along the length of the transmissive wire 22 having the sheet 28 disposed about the transmissive element 24, such as the point/position shown in FIG. 2.

It will of course be understood that depending on particular applications, additional modification to the continuous length of transmissive wire 22 formed by the process 20 may take place. Sections of the sheet 28 may be removed to allow for access to the transmissive element 24. For example, at a particular position along the central longitudinal axis 32, a full or partial circumferential extent of the sheet 28 may be removed. In some embodiments, axial end portions of the sheet 28 may be removed to expose axial end portions of the transmissive element 24.

Referring now to the components from which the transmissive wire 22 is formed, the sheet 28 preferably comprises one or more nanomaterials, and also may be referred to as a film. As used herein, a nanomaterial includes a material having particles or elements having nanometer scale dimensions. The sheet 28 may be formed by any suitable method such as by successive drawing, such as from a suitable nanomaterial array, for example. Other suitable methods of formation of the nanomaterial sheet 28 may include a roll-to-roll process or a spraying or other deposition process to form a sheet 28 having a relatively small thickness. For example, a suitable nanomaterial sheet 28 may have a thickness in a range of about 0.1 micrometers to about 10 micrometers, or about 0.2 micrometers to about 1 micrometers, or about 0.5 micrometers in thickness. The nanomaterial of the sheet 28 may include nanotube structures and/or may include any suitable material such as carbon, boron nitride, cadmium sulfide, graphene, or silicon nitride. In some embodiments, the sheet 28 may include a conductive material, such as an electrically conductive material.

The transmissive element 24 may include any material suitable for the transmissive application of the transmissive wire 22, which application may be electrical transmission, optical transmission, thermal transmission, or transmission of another signal type. The transmissive element 24 may be metallic, nearly-metallic, or ceramic, and may include titanium, gold, tungsten, etc.

The transmissive element 24 may include a pre-formed wire or may be formed by any one or more of evaporation, electroplating, sputtering, atomic layer deposition or chemical vapor deposition, which formation method may be conducted separate from the sheet 28 or directly on a surface 34 of the sheet 28. Where the transmissive element 24 is formed directly on the sheet 28, such formation may be at one or both of the opposite major surfaces 34 of the sheet 28. Likewise, a pre-formed transmissive element 24 also may be applied to one or both of the opposite major surfaces 34 of the sheet 28.

Depending on the method of formation of the transmissive element 24 as applied to the sheet 28, the thickness of the transmissive element 24 may be in the range of about 1 nanometer to about 1 micrometer, or about 10 nanometers to about 500 nanometers in thickness. An alternative thickness may be small or larger than these ranges. For example, where a pre-formed film or wire is provided as the transmissive element 24, the thickness of the transmissive element 24 may be in the range of about 0.1 micrometers to about 10 micrometers, or about 0.2 micrometers to about 1 micrometers, or about 0.5 micrometers in thickness.

As will be apparent from the aforementioned methods of formation of the transmissive element 24 and of the nanomaterial sheet 28, the transmissive element 24 and the nanomaterial sheet 28 each may be formed separately and then applied to one another. Alternatively, one of the transmissive element 24 and the nanomaterial sheet 28 may be formed on a surface of the other of the transmissive element 24 and the nanomaterial sheet 28 having been already formed. An embodiment may include where the transmissive element 24 and the nanomaterial sheet 28 are jointly formed, such as adjacent or contiguous one another.

The resulting transmissive wire 22 formed from the transmissive element 24 and the nanomaterial sheet 28 may have an average diameter over the longitudinal length of the transmissive wire 22 in the range of about 0.5 micrometers to about 20 micrometers, or about 1 micrometers to about 10 micrometers, or about 5 micrometers in diameter.

The resulting transmissive wire 22 combines the benefit of a transmissive, such as conductive, core protected from environmental, thermal, and chemical exposure by overlapping layers of nanomaterial wrapped or wound about the core. The nanomaterial sheet 28 provides mechanical strength—in bending, tension, and shear—to the transmissive wire 22, protecting the core of the transmissive element 24 and providing for ease of handling, winding, and forming of the wire 22.

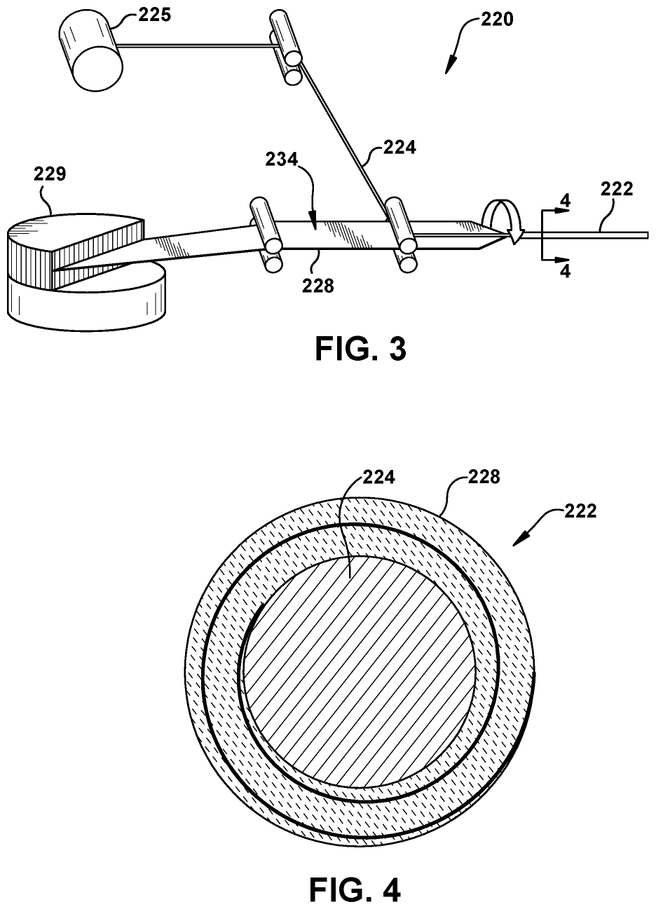

Referring now to FIGS. 3 to 12, additional exemplary processes for making a transmissive wire and additional embodiments of transmissive wires are shown. The description of the exemplary process 20 and the exemplary transmissive wire 22 are applicable to each of the additional embodiments of exemplary processes and transmissive wires except as noted below. Moreover, it will be appreciated upon reading and understanding the specification that aspects of the processes and transmissive wires may be substituted for one another or used in conjunction with one another where applicable.

Turning now to FIGS. 3 and 4, a process 220 is illustrated for forming a transmissive wire 222. The process 220 includes continuously applying a transmissive element 224 pulled from a wire supply 225 along a continuous longitudinal length of one of two opposed major surfaces 234 of a sheet 228. The transmissive element 224 comprises a pre-formed wire of a transmissive material. The sheet 228 comprises a nanomaterial and is continuously drawn from a nanotube array 229. The sheet 228 is wrapped about the transmissive element 224 and about a longitudinal axis of the sheet 228 to form the transmissive wire 222. As shown in the cross-sectional view of FIG. 4 taken along section 4-4 of FIG. 3, a full-circumferential extent of the transmissive element 224 is retained radially inwardly of an outermost full circumferential extent of the wrapped sheet 228.

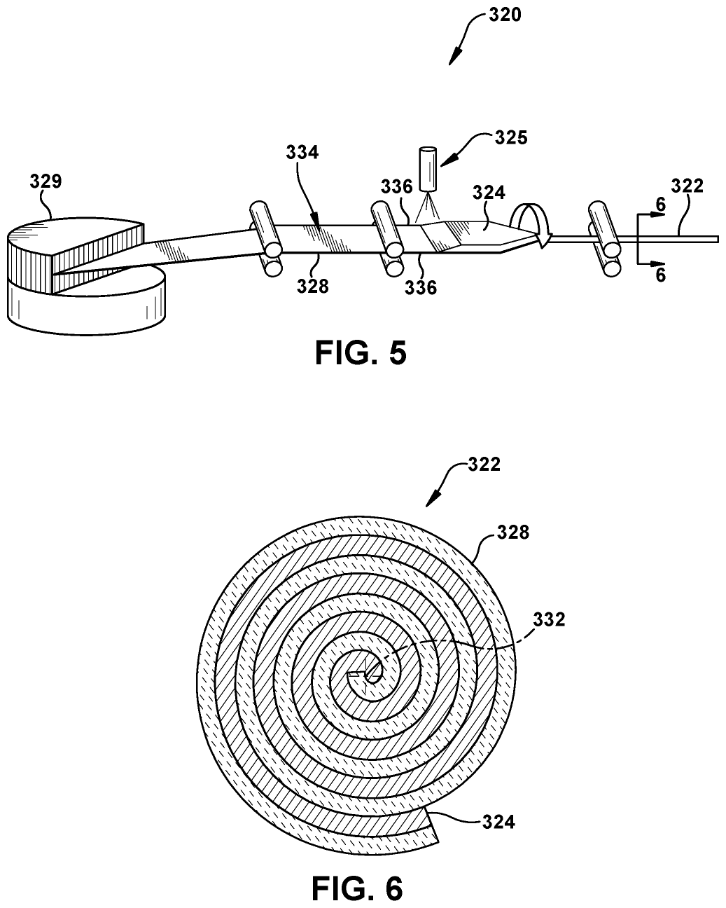

Turning next to FIGS. 5 and 6, a process 320 is illustrated for forming a transmissive wire 322. The process 320 includes continuously applying a transmissive element 324 formed from a supply 325 of a transmissive material along a continuous length of a sheet 328. The transmissive element 324 comprises a material layer that is deposited on the sheet 328, such as by any one or more of evaporation, electroplating, sputtering, atomic layer deposition or chemical vapor deposition, for example. The sheet 328 comprises a nanomaterial and is continuously drawn from a nanotube array 329. The transmissive element 324 is affixed to the sheet 328 via the deposition process and extends a full lateral extent of one of two opposed major surfaces 334 of the sheet 328 between opposed laterally-extending edges 336. The sheet 328 and affixed layer of transmissive element 324 are jointly wrapped about a longitudinal axis extending along one of the free laterally-extended edges 336 of the sheet 328 to form the transmissive wire 322. As shown in the cross-sectional view of FIG. 6 taken along section 6-6 of FIG. 5, a partial portion of the transmissive element 224 is exposed to an external environment, with the cross-section defined as a spiral with of the overlaid sheet 328 and element 324, and forming alternating layers of sheet 328 and element 324 extending outwardly from a central longitudinal axis 332 of the transmissive wire 322.

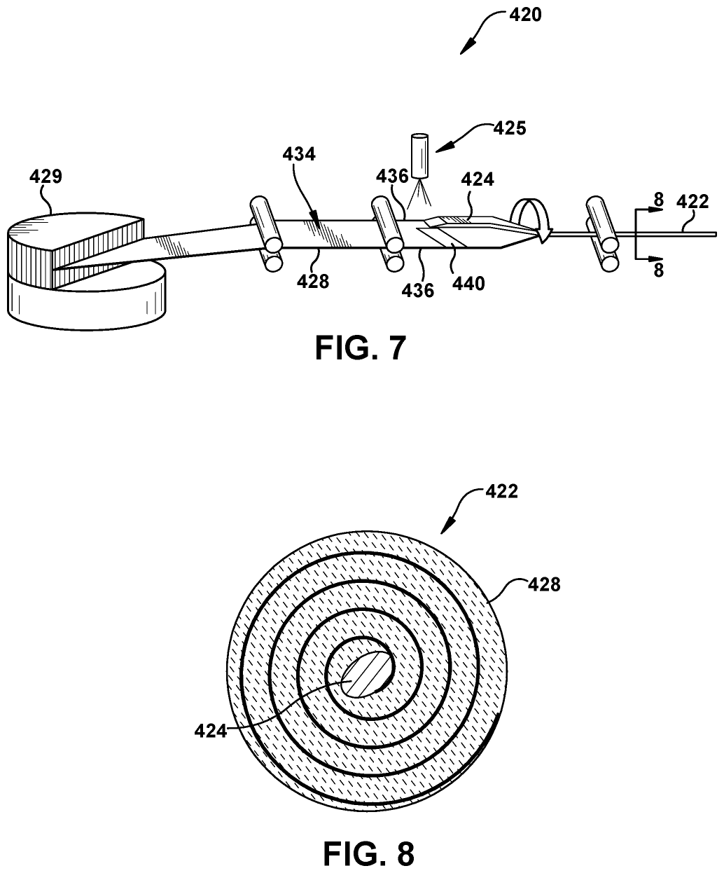

Turning now to FIGS. 7 and 8, a process 420 is illustrated for forming a transmissive wire 422. The process 420 includes continuously applying a transmissive element 424 formed from a supply 425 of a transmissive material along a continuous longitudinal length of a sheet 428. The transmissive element 424 comprises a material layer that is deposited on the sheet 428, such as by any one or more of electroplating, sputtering, atomic layer deposition or chemical vapor deposition, for example. The sheet 428 comprises a nanomaterial and is drawn from a nanotube array 429. The transmissive element 424 is affixed to the sheet 428 via the deposition process and extends over only a partial lateral extent of one of two opposed major surfaces 434 of the sheet 428 extending between opposed laterally-extending edges 436.

A mask 440 may be used to restrict or to altogether prevent deposition of transmissive material onto a remaining lateral extent of the respective surface 434 of the sheet 428 that extends along an edge 436 of the sheet 428 opposite the edge 436 adjacent the section of the sheet 428 to be deposited upon. In this way, the transmissive element 424 comprises a layer affixed to a longitudinally extending lateral edge portion of the sheet 428, and an opposite lateral edge portion is free from transmissive element affixation.

The sheet 428 and affixed layer of transmissive element 424 are jointly wrapped about a longitudinal axis extending along the free laterally-extending edge 436 adjacent the transmissive element 424. Accordingly, as depicted in FIG. 8 taken along section 8-8 of FIG. 7, one laterally-extending free edge 436 of the sheet 428 is wrapped about the opposing laterally-extending free edge 436 of the sheet 428. In this way, the transmissive element 424 is wrapped radially inwardly of the sheet 428 to form a central core of the transmissive wire 422.

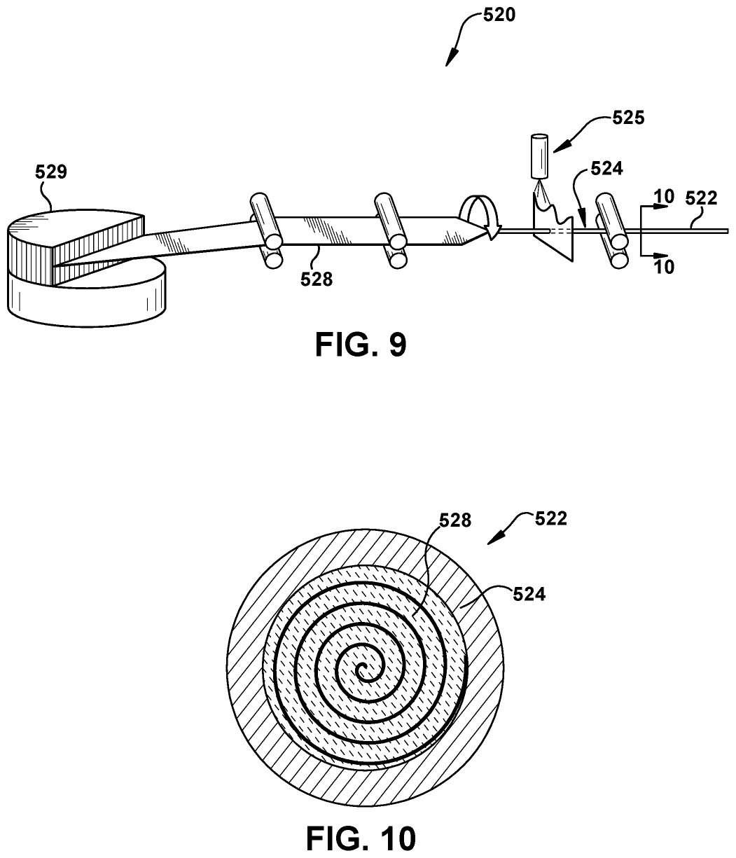

Turning next to FIGS. 9 and 10, a process 520 is illustrated for forming a transmissive wire 522. The process 520 includes continuously applying a transmissive element 524 formed from a supply 525 of a transmissive material along a continuous length of a sheet 528, where the sheet 528 is pre-wrapped to have a generally cylindrical cross-section. The transmissive element 524 comprises a material layer that is deposited on an outer circumferential extent of the sheet 528, such as on a full outer circumferential extent, and such as by any one or more of electroplating, sputtering, atomic layer deposition or chemical vapor deposition, for example. The sheet 528 comprises a nanomaterial and is continuously drawn from a nanotube array 529. The transmissive element 524 is affixed to the sheet 528 via the deposition process. As shown in the cross-sectional view of FIG. 10 taken along section 10-10 of FIG. 9, the transmissive element 524 provides an external coating or sheath disposed radially outwardly of a nanomaterial sheet core.

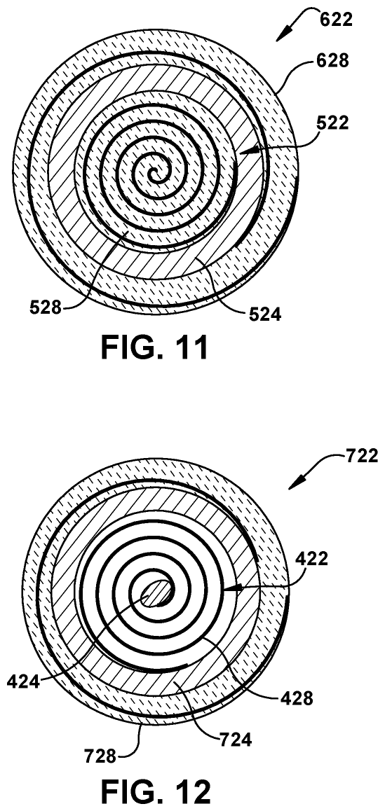

Next, FIGS. 11 and 12 illustrate additional transmissive wires 622 and 722, respectively, formed via combinations or partial combinations of processes of the aforementioned embodiments, such as to provide transmissive wires having additional layers. The layers may include additional transmissive elements radially spaced from, and fully radially separated from, one another.

Turning first to FIG. 11, a transmissive wire 622 is formed by wrapping a second nanomaterial sheet 628 about the transmissive wire 522 of FIG. 10.

Turning last to FIG. 12, a transmissive wire 722 includes a plurality of transmissive cores radially spaced from one another. The transmissive wire 722 is continuously formed from the process 420 of FIG. 7, with a second wire layer being continuously applied and wrapped about the transmissive wire 422 to form the transmissive wire 722. As depicted, an external coating transmissive element 724 is deposited, such as by any one or more of electroplating, sputtering, atomic layer deposition or chemical vapor deposition, about the transmissive wire 422, with a second nanomaterial sheet 728 wrapped about the transmissive element 724. This process allows for more than one signal or signal type to be transmitted along the transmissive wire 722.

In summary, and with reference to each of the aforementioned embodiments, the present disclosure provides a transmissive element 24, 224, 324, 424, 524, 624, 724 having micrometer or nanometer scale thickness may be continuously applied, such as fixedly applied, to a nanomaterial structure 28, 228, 328, 428, 528, 628, 728, or vice versa, and the combined structure jointly wrapped about an axis of the nanomaterial structure 28, 228, 328, 428, 528, 628, 728 to produce a transmissive wire 22, 222, 322, 422, 522, 622, 722. In one example, a continuously formed transmissive element 24, 224, 324, 424, 524, 624, 724 may be applied to a continuously formed length of a nanomaterial sheet 28, 228, 328, 428, 528, 628, 728 with the combined structure being wrapped about a longitudinal axis of the nanomaterial sheet 28, 228, 328, 428, 528, 628, 728 to form a transmissive wire 22, 222, 322, 422, 522, 622, 722 having a micrometer or nanometer scale diameter along the longitudinal axis of the formed transmissive wire 22, 222, 322, 422, 522, 622, 722. The method of forming the exemplary transmissive wire 22, 222, 322, 422, 522, 622, 722 may provide for a generally highly conductive, mechanically robust transmissive wire 22, 222, 322, 422, 522, 622, 722, which may have additional thermal, optical, or chemical advantages, for example.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, stores, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A transmissive wire, comprising:
a sheet comprising a nanomaterial, the sheet being wrapped about a longitudinal axis of the sheet; and
a transmissive element enabling transmission of a signal along the transmissive wire, the transmissive element continuously extending along the transmissive wire and being wrapped within the sheet, at least a portion of the transmissive element at each distance along a longitudinal length of the transmissive wire being radially inwardly spaced from a radially outermost portion of the wrapped sheet at the same respective distance.

2. The transmissive wire of claim 1, wherein the transmissive wire has an average diameter over the longitudinal length of the transmissive wire of 0.5 micrometers to 20 micrometers.

3. The transmissive wire of claim 1, wherein the longitudinal axis of the sheet about which the sheet is wrapped is disposed along a laterally-extending free edge of the sheet, wherein one laterally-extending free edge of the sheet is wrapped about the opposing laterally-extending free edge of the sheet.

4. The transmissive wire of claim 1, wherein a full circumferential extent of the transmissive element about a longitudinal axis of the transmissive wire is retained within the transmissive wire, spaced radially inward from a radially outermost circumferential extent of the wrapped sheet.

5. The transmissive wire of claim 1, wherein the transmissive element comprises a layer affixed to the sheet such that the transmissive element and the sheet are jointly wrapped about the longitudinal axis of the sheet.

6. The transmissive wire of claim 1, wherein the transmissive element comprises a layer affixed to a longitudinally extending lateral edge portion of the sheet, and wherein an opposite lateral edge portion is free from transmissive element affixation.

7. The transmissive wire of claim 1, wherein the transmissive element includes a conductive metal.

8. The transmissive wire of claim 1, wherein the transmissive element includes a ceramic.

9. The transmissive wire of claim 1, wherein the sheet comprises nanotubes.

10. A transmissive wire, comprising:
a sheet comprising a nanomaterial, the sheet being wrapped about a longitudinal axis of the sheet; and
a transmissive element enabling transmission of a signal along the transmissive wire, the transmissive element continuously extending along the transmissive wire and being wrapped within the sheet, at least a portion of the transmissive element at each distance along a longitudinal length of the transmissive wire being radially inwardly spaced from a radially outermost portion of the wrapped sheet at the same respective distance, and
wherein the transmissive element is formed from a material that is deposited to the sheet such that the transmissive element is affixed to the sheet allowing for the transmissive element and the sheet to be jointly wrapped about a longitudinal axis of the sheet.

11. A method of making a nanomaterial encased transmissive wire, the method comprising:
continuously applying a transmissive element along a continuous length of a sheet comprising a nanomaterial, the transmissive element enabling transmission of a signal along the transmissive wire; and
wrapping the sheet about the transmissive element and about a longitudinal axis of the sheet to form the transmissive wire, wherein at least a portion of the transmissive element at each distance along a longitudinal length of the transmissive wire is radially inwardly spaced from a radially outermost portion of the wrapped sheet at the same respective distance.

12. The method of claim 11, wherein the applying step includes forming the transmissive layer on the sheet by evaporation, sputtering, electroplating, vapor deposition, or atomic layer deposition.

13. The method of claim 11, wherein the applying step includes affixing the transmissive element to the sheet such that the transmissive element and the sheet are jointly wrappable about the longitudinal axis of the sheet.

14. The method of claim 11, wherein the applying step includes applying the transmissive element to a longitudinally extending lateral edge portion of the sheet, wherein an opposite lateral edge portion is free from transmissive element application.

15. The method of claim 11, wherein the applying step includes affixing a conductive metal to the sheet.

16. The method of claim 11, wherein the applying step includes applying a ceramic to the sheet.

17. The method of claim 11, wherein the wrapping step includes forming a transmissive wire having an average diameter over the longitudinal length of the transmissive wire of about 0.5 micrometers to about 20.0 micrometers.

18. The method of claim 11, wherein the wrapping step includes retaining a full circumferential extent of the transmissive element spaced radially inward from a radially outermost circumferential extent of the wrapped sheet.

19. The method of claim 11, wherein the wrapping step includes wrapping one laterally-extending free edge of the sheet about the opposing laterally-extending free edge of the sheet, wherein the longitudinal axis of the sheet about which the sheet is wrapped is disposed at a laterally-extending free edge of the sheet.

20. The method of claim 11, wherein the sheet and the transmissive element comprise a first sheet and a first transmissive element, and the method further including
continuously applying a second transmissive element along a continuous length of a second sheet comprising a nanomaterial; and
wrapping the second sheet and the second transmissive element about the first the first sheet and the first transmissive element.
